(19) United States
(12) Patent Application Publication
(10) Pub. No.: US 2008/0117125 A1
(43) Pub. Date: May 22, 2008

(54) Plasma display and driver thereof

(76) Inventor: Yoo-Jin Song, Suwon-si (KR)

Correspondence Address: Robert E. Bushnell, Suite 300, 1522 K Street, N.W., Washington, DC, 20005-1202, US

(21) Appl. No.: 11/826,748

(22) Filed: Jul. 18, 2007

(30) Foreign Application Priority Data
Nov. 20, 2006 (KR) 10-2006-0114683

(51) Int. Cl. G09G 3/28

(52) U.S. Cl. 345/60; 345/204; 345/67

(57) ABSTRACT

A plasma display driver and a plasma display having such a driver includes: a first switching transistor, a switching controller, first to third input and output terminals, and fourth and fifth input and output terminals. The switching controller generates a switching control signal, according to the input signal, to turn a first switching transistor on and off. The first to third input and output terminals respectively output a power source voltage, a ground voltage, and the input signal to the switching controller. The fourth and fifth input and output terminals are respectively coupled to a drain and a source of the first switching transistor.

### CLAIM OF PRIORITY

This application makes reference to, incorporates the same herein, and claims all benefits accruing under 35 U.S.C. 119 from an application for PLASMA DISPLAY AND DRIVER THEREOF earlier filed in the Korean Intellectual Property Office on the 20^{th} day of November 2006 and there duly assigned Serial No. 10-2006-0114683.

### BACKGROUND OF THE INVENTION

1. Field of the Invention

The present invention relates to a plasma display, and more particularly, the present invention relates to a driver of a plasma display.

2. Description of the Related Art

A plasma display includes a Plasma Display Panel (PDP) that uses a plasma generated by a gas discharge process to display characters or images. The PDP includes, depending on its size, more than several scores to millions of pixels arranged in a matrix pattern.

A panel of the plasma display includes power supplies for supplying various high voltages (e.g., a sustain discharge voltage Vs, an address voltage Va, a reset voltage Vset, and a scan voltage) for generating a plasma discharge to a driving circuit, and for supplying low voltages to other circuit elements (e.g., an image processor, a fan, an audio unit, and a control circuit.

A driver of the plasma display operates a switching transistor according to a level of a signal input from a controller to selectively supply voltages to a plurality of electrodes in a Plasma Display Panel (PDP).

FIG. 1 is a diagram of a plasma display driver.

As shown in FIG. 1, the plasma display driver includes a gate driving integrated circuit 10, an amplification circuit 20, and a switching transistor 30.

The gate driving integrated circuit 10 generates a control signal for controlling a turning on/off operation of the switching transistor 30 according to a voltage level of a received input signal, and transmits the control signal to an input terminal of the amplification circuit 20.

The amplification circuit 20 is generally formed by a Push Pull circuit including two switching transistors 21 and 22. The two switching transistors 21 and 22 are alternately turned on and off according to the control signal input from the gate driving integrated circuit 10, and the amplification circuit 20 amplifies the control signal to generate a switching control signal for controlling the turning on/off operation of the switching transistor 30.

The switching transistor 30 changes the amount of currents output through a source terminal according to the switching control signal, and therefore a level of a voltage supplied to the PDP is changed.

However, since it is difficult to realize integration in the plasma display driver of FIG. 1 because of realizing area of respective constituent elements of the driver, it is difficult to minimize the number of layers of a Printed Circuit Board (PCB).

In addition, since a driving board for mounting the plasma display driver includes drivers, which correspond to various driving waveforms to be supplied to the PDP, in a limited area, it is difficult to pattern the driving board, and a voltage distorted by noise is easily transmitted to the PDP through the driver.

To solve the above problem, an Intelligent Power Module (IPM) or a High Voltage Integrated Circuit (HVIC) that combines the switching transistor 30, the amplification circuit 20, and the gate driving integrated circuit 10 in the driver as one package is used.

However, in the IPM or the HVIC, since there is a problem in that different sizes of switching transistors according to the size of the PDP is printed on the driving board, the gate driving integrated circuit is additionally purchased and is mounted on a substrate having the printed switching transistor, and wire bonding and molding operations are performed, it is necessary to provide an integrated switch.

### SUMMARY OF THE INVENTION

The present invention has been made in an effort to provide a plasma display for easily performing as a driving board and for preventing output voltage distortion, and a driver thereof.

An exemplary plasma display driver to drive first and second electrodes of a plasma display, and to drive a third electrode of the plasma display arranged in a direction crossing the first and second electrodes in response to an input signal input from a controller, includes: a first switching transistor; a switching controller to generate a switching control signal, according to the input signal, to control turning a first switching transistor on and off; first to third input and output terminals to output a power source voltage, a ground voltage, and the input signal to the switching controller; and fourth and fifth input and output terminals respectively coupled to a drain and a source of the first switching transistor.

The driver preferably further includes a second switching transistor including a source and drain that are commonly respectively coupled to the source and drain of the first switching transistor, the second switching transistor operating in response to the switching control signal.

The driver preferably further includes a sixth input and output terminal to output a driving control signal to the switching controller control to control an operation thereof.

The switching controller preferably generates the switching control signal corresponding to a level of the input signal according to the driving control signal, or turns off the switching transistor regardless of the input signal.

The driver preferably further includes a first resistor including a terminal coupled to the source terminal of the first switching transistor and another terminal coupled to the fifth input and output terminal, and a voltage detection path to transmit a first voltage, corresponding to currents flowing from the source terminal to the fifth input and output terminal, to the switching controller through the first resistor.

The switching controller preferably varies the switching control signal according to a level of the first voltage.

The driver preferably further includes a first capacitor including a terminal coupled to the first input and output terminal and another terminal coupled to the source terminal of the first switching transistor.

The driver preferably further includes a seventh input and output terminal coupled to the source terminal of the switching transistor.

An exemplary plasma display includes: a Plasma Display Panel (PDP) having first and second electrodes, and having a third electrode arranged in a direction crossing the first and second electrodes; first to third driving circuit units to respectively driving the first to third electrodes; and a controller to supply a control signal to the first to third driving circuit units; the first to third driving circuit units each include: a first switching transistor; a switching controller to generating a switching control signal to turn the first switching transistor on and off in response to the control signal; first to third input and output terminals to respectively output a power source voltage, a ground voltage, and the input signal to the switching controller; and fourth and fifth input and output terminals respectively coupled to a drain and a source of the first switching transistor.

The plasma display preferably further includes a second switching transistor including a source and drain that are commonly respectively coupled to the source and drain of the first switching transistor, the second switching transistor operating in response to the switching control signal.

The plasma display preferably further includes a sixth input and output terminal to output a driving control signal to the switching controller control to control an operation thereof.

The switching controller preferably generates the switching control signal corresponding to a level of the input signal according to the driving control signal, or turns off the switching transistor regardless of the input signal.

The plasma display preferably further includes a first resistor including a terminal coupled to the source terminal of the first switching transistor and another terminal coupled to the fifth input and output terminal, and a voltage detection path to transmit a first voltage, corresponding to currents flowing from the source terminal to the fifth input and output terminal, to the switching controller through the first resistor.

The switching controller preferably varies the switching control signal according to a level of the first voltage.

The plasma display preferably further includes a first capacitor including a terminal coupled to the first input and output terminal and another terminal coupled to the source terminal of the first switching transistor.

The plasma display preferably further includes a seventh input and output terminal coupled to the source terminal of the switching transistor.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a diagram of a plasma display driver.

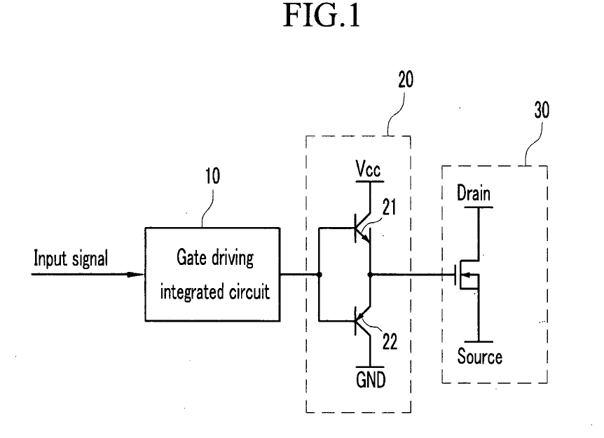

FIG. 2 is a block diagram of a plasma display according to an exemplary embodiment of the present invention.

FIG. 3 is a diagram of a plasma display driver according to a first exemplary embodiment of the present invention.

FIG. 4 is a diagram of a plasma display driver according to a second exemplary embodiment of the present invention.

FIG. 5 is a diagram of a plasma display driver according to a third exemplary embodiment of the present invention.

FIG. 6 is a diagram of a plasma display driver according to a fourth exemplary embodiment of the present invention.

FIG. 7 is a diagram of a plasma display driver according to a fifth exemplary embodiment of the present invention.

FIG. 8 is a diagram of a plasma display driver according to a sixth exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, when it is described that an element is “coupled” to another element, the element may be “directly coupled” to the other element or “electrically coupled” to the other element through a third element. In addition, unless explicitly described to the contrary, the word “comprise” or variations such as “comprises” or “comprising” will be understood to imply the inclusion of stated elements but not the exclusion of any other elements.

A plasma display according to an exemplary embodiment of the present invention and a driver thereof are described as follows with reference to the drawing figures.

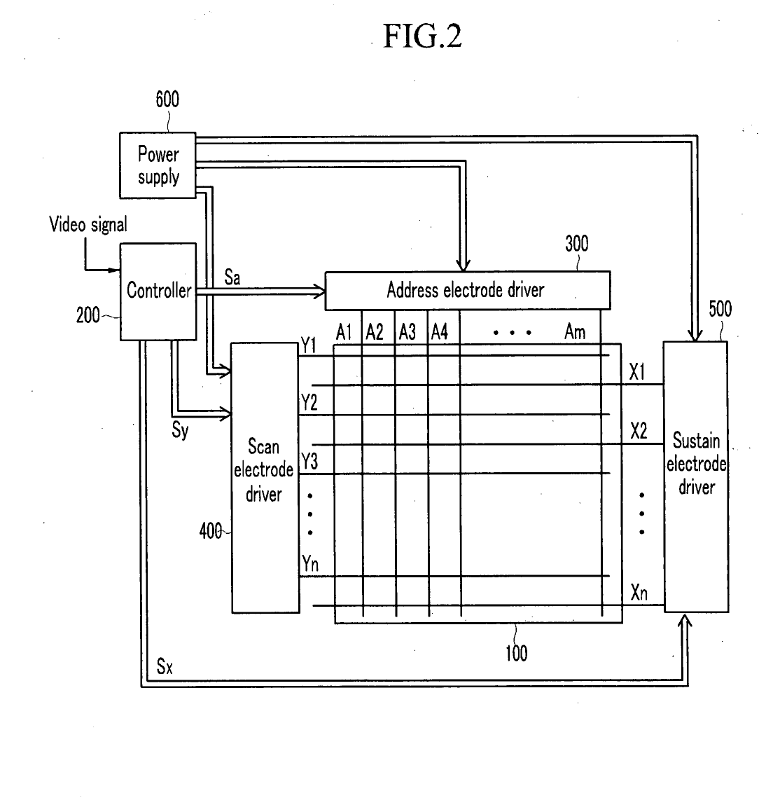

FIG. 2 is a block diagram of a plasma display according to the exemplary embodiment of the present invention.

As shown in FIG. 2, the plasma display according to the exemplary embodiment of the present invention includes a Plasma Display Panel (PDP) 100, a controller 200, an address electrode driver 300, a scan electrode driver 400, a sustain electrode driver 500, and a power supply 600.

The PDP 100 includes a plurality of address electrodes A1 to Am extending in a column direction, and a plurality of sustain and scan electrodes X1 to Xn and Y1 to Yn in pairs extending in a row direction. The sustain electrodes X1-Xn are formed in respective correspondence to the scan electrodes Y1 to Yn, and ends of the sustain electrodes X1-Xn are connected in common.

In addition, the PDP 100 includes a substrate (not shown) having the sustain and scan electrodes X1-Xn and Y1 to Yn, and a substrate (not shown) having the address electrodes A1-Am. The two substrates are arranged to face each other with a discharge space between them so that the scan electrodes Y1 to Yn and the sustain electrodes X1-Xn may cross the address electrodes A1-Am. Discharge spaces provided at crossing regions of the address electrodes and X and Y electrodes form discharge cells. This configuration of the plasma display panel 100 is an example, and other configurations of a panel for supplying driving waveforms that will be described may be applied to the present invention.

The controller 200 receives external video signals, and outputs an address driving control signal Sa, a sustain electrode driving control signal Sx, and a scan electrode driving control signal Sy. In addition, the controller 200 divides a frame into a plurality of subfields, and each subfield has a reset period, an address period, and a sustain period in a temporal manner. Furthermore, the controller 200 uses a direct current voltage transmitted from the power supply 600, generates a high scan voltage Vscan_h supplied to a cell that is not addressed during the address period, and transmits the high scan voltage Vscan_h to the scan electrode driver 400 or the sustain electrode driver 500.

After receiving the address driving control signal Sa from the controller 200, the address electrode driver 300 supplies a display data signal for selecting discharge cells to be displayed to the respective address electrodes A1-Am.

The scan electrode driver 400 receives the scan electrode driving control signal Sy 21 from the controller 200, and supplies the driving voltage to the scan electrode Y.

The sustain electrode driver 500 receives the sustain electrode driving control signal Sx from the controller 200, and supplies a driving voltage to the sustain electrode X.

The power supply 600 supplies a power source for driving the plasma display to the controller 200, and drivers 300, 400, and 500.

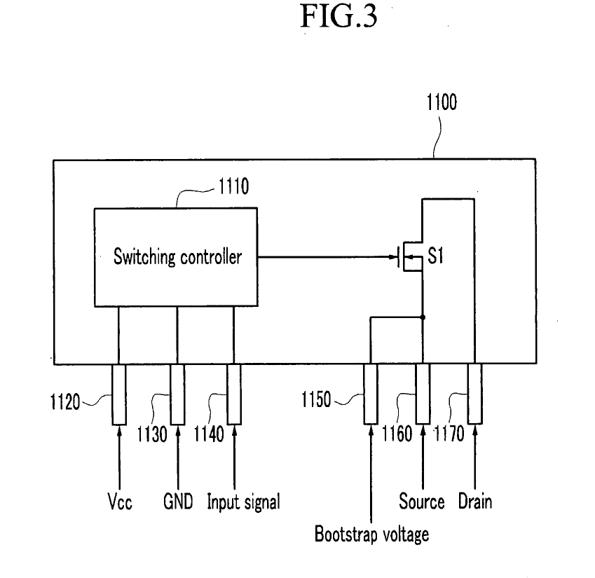

A one-chip driver in the address electrode driver 300, the scan electrode driver 400, and the sustain electrode driver 500 according to the exemplary embodiment of the present invention is described below with reference to FIGS. 3 to 5.

FIG. 3 is a diagram of a plasma display driver according to a first exemplary embodiment of the present invention.

As shown in FIG. 3, the plasma display driver 1100 according to the first exemplary embodiment of the present invention includes a switching controller 1110 and a switching transistor S1, and is a one-chip driver that is contained within one single chip.

The switching controller 1110 receives an input signal, a power voltage Vcc, and a ground voltage GND from the controller 200 or the power supply 600 respectively through a first input and output terminal 11200, a second input and output terminal 11300, and a third input and output terminal 11400, and generates a switching control signal for controlling an operation of the switching transistor S1.

The switching transistor S1 changes the amount of currents output through a source terminal according to the switching control signal, and therefore a level of a voltage supplied to the PDP is changed. A main switch is illustrated as being a Metal-Oxide Semiconductor Field Effect Transistor (MOSFET) in FIG. 3. However, other types of switches may be used for the main switch. A source terminal of the switching transistor S1 is coupled to the fifth X input and output terminal 11600, and a drain terminal thereof is coupled to the sixth input and output terminal 11680. The fourth input and output terminal 11500 for receiving a bootstrap voltage is coupled to the source terminal of the switching transistor S1 and maintains a source terminal output signal at a level that is higher than a voltage supplied to the PDP. A voltage level of the source terminal output signal is increased by using the bootstrap voltage since a circuit neighboring the plasma display driver 1100 according to the exemplary embodiment of the present invention generally performs a high side operation with a voltage level that is higher than the voltage level of the voltage supplied to the PDP.

Rather than transmitting the control signal from the gate driving integrated circuit to the switching transistor through a line patterned on the driving board in the plasma display driver, the plasma display driver 1100 according to the first exemplary embodiment of the present invention is formed by one chip, and therefore, an amplification circuit for compensating attenuation of an output signal of the gate driving integrated circuit is not provided. Accordingly, the number of constituent elements may be reduced, and a cost for realizing the plasma display may be reduced.

In addition, differing from the IPM or HVIC that requires combining the gate driving integrated circuit and the switching transistor as one package, since the switching controller 1110 and the switching transistor SI are formed by one single chip in the plasma display driver 1100 according to the first exemplary embodiment of the present invention, a manufacturing process of the plasma display may be simplified.

Furthermore, since the plasma display driver 1100 according to the first exemplary embodiment of the present invention is the one-chip driver in which a plurality of input and output terminals 1120 to 1170 are vertically disposed on a printed substrate, the number of layers of the printed substrate may be minimized, the noise may be reduced, and shortage of ground patterns may be solved. More particularly, the shortage of the ground patterns of the gate driving integrated circuit in the plasma display driver causes an impedance difference between the gate driving integrated circuit and the switching transistor. However, since the switching controller 1110 and the switching transistor S1 are connected by using the one single chip in the plasma display driver 1100 according to the first exemplary embodiment of the present invention, there is no impedance difference between the switching controller 1110 and the switching transistor S1.

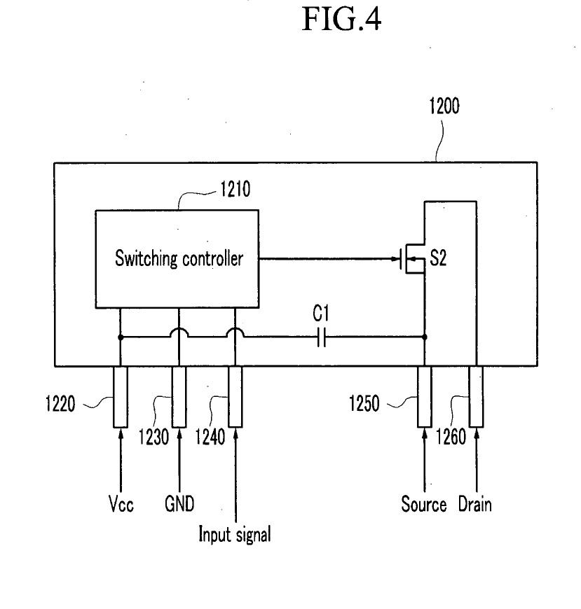

FIG. 4 is a diagram of a plasma display driver according to a second exemplary embodiment of the present invention.

The plasma display driver 1200 of FIG. 4 according to the second exemplary embodiment of the present invention is similar to the one-chip plasma display driver 1100 of FIG. 3 according to the first exemplary embodiment of the present invention, and therefore, descriptions of previously described parts have been omitted.

As shown in FIG. 4, rather than including the bootstrap voltage input terminal in the plasma display driver 1100 according to the first exemplary embodiment of the present invention, the plasma display driver 1200 according to the second exemplary embodiment of the present invention includes a bootstrap capacitor C1 having a terminal coupled to a first input and output terminal 1220 and another terminal coupled to a source terminal of a switching transistor S2. The bootstrap capacitor C1 is charged by a power source voltage Vcc input through the first input and output terminal 1220, and therefore, a level of voltage of an output signal output through the source terminal of the switching transistor S2 increases.

In the plasma display driver 1200 according to the second exemplary embodiment of the present invention, since the same effect as the plasma display driver 1100 according to the first exemplary embodiment of the present invention may be achieved and the number of the input and output terminals may be further reduced, the design of a printed substrate may be easily patterned.

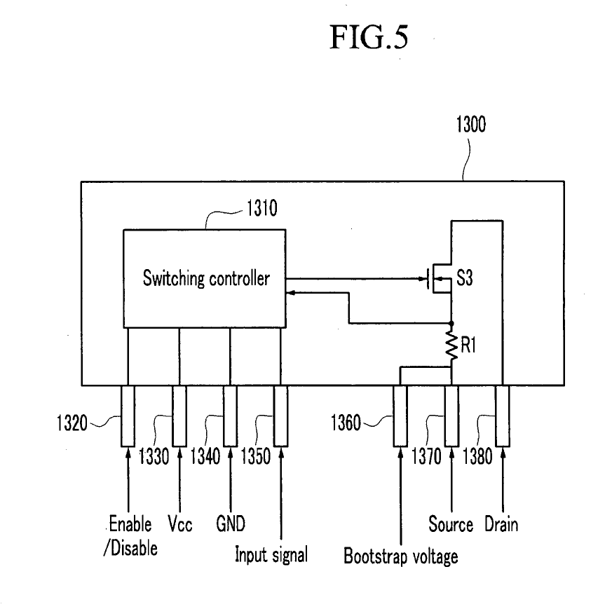

FIG. 5 is a diagram of a plasma display driver according to a third exemplary embodiment of the present invention.

The plasma display driver 1300 of FIG. 5 according to the third exemplary embodiment of the present invention is similar to the one-chip plasma display drivers 1100 and 1200 of FIGS. 3 and 4 according to the first and second exemplary embodiments of the present invention, and therefore, descriptions of previously described parts have been omitted.

A switching controller 1310 receives an enable or disable signal through a first input and output terminal 1320 for receiving an external control signal for controlling an operation of the driver 1300 of the plasma display according to the third exemplary embodiment of the present invention. The switching controller 1310 outputs a switching control signal according to an input signal input through a fourth input and output terminal 1350 to operate a switching transistor S3 when receiving the enable signal through the first input and output terminal 1320, and it turns off the switching transistor S3 regardless of an input signal when receiving the disable signal.

In addition, a resistor R1 is additionally connected to a source terminal of the switching transistor S3, and a voltage corresponding to the amount of currents flowing through a source terminal 1370 is transmitted to the switching controller 1310 through the resistor R1. The switching controller 1310 compares the input voltage to a predetermined reference voltage. When a voltage level of the input voltage is higher than the voltage level of the reference voltage, the switching controller 13 10 turns off the switching transistor S3 for a predetermined time to prevent neighboring circuits from being damaged by an over-current flowing through the source terminal 1370.

The driver 1300 of the plasma display according to the third exemplary embodiment of the present invention uses a fifth input and output terminal 1360 for receiving the bootstrap voltage. However, the fifth input and output terminal 1360 may be eliminated, and the bootstrap capacitor having a terminal coupled to a second input and output terminal 1330 and another terminal coupled to the source terminal of the switching transistor S3 may be used in a like manner of the driver 1200 of the plasma display of FIG. 4 according to the second exemplary embodiment of the present invention.

In the driver 1300 of the plasma display according to the third exemplary embodiment of the present invention, functions for controlling the operation of driver 1300 using the external control signal and preventing the over-current are additionally provided, and therefore, the PDP 100 of FIG. 2 may be driven according to the intention of a circuit designer.

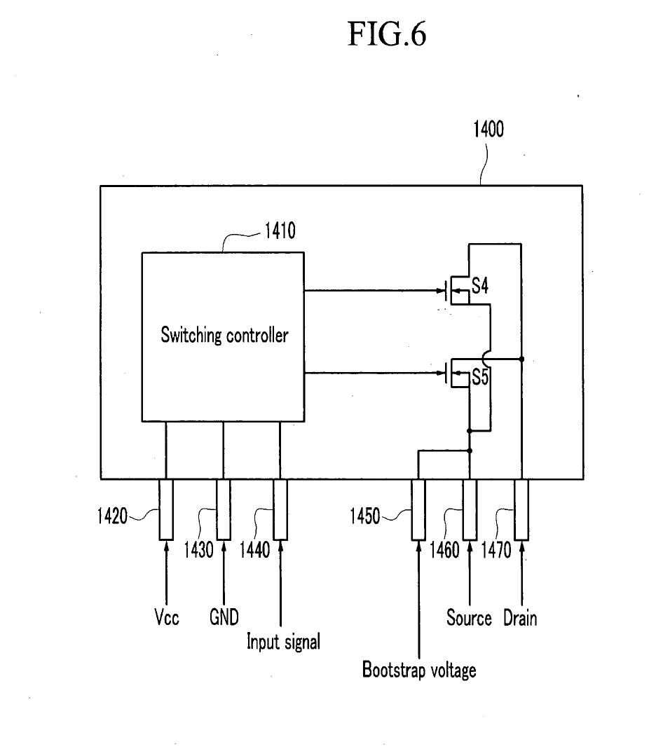

FIG. 6 is diagram of a plasma display driver according to a fourth exemplary embodiment of the present invention.

As shown in FIG. 6, the driver 1400 according to the fourth exemplary embodiment of the present invention includes a switching controller 1410, a first switching transistor S4, a second switching transistor S5, and first to sixth input and output terminals 1420, 1430, 1440, 1450, 1460, and 1470.

The driver 1400 of the plasma display of FIG. 6 according to the fourth exemplary embodiment of the present invention is similar to the driver 1100 of the plasma display shown in FIG. 3 according to the first exemplary embodiment of the present invention except that first and second switching transistors S4 and S5 are provided, and source and drain terminals of the respective switching transistors are commonly connected to the fifth and sixth input and output terminals 1460 and 1470.

Since the switching controller 1410 outputs a switching control signal according to an input signal, which is received through the third input and output terminal 1440, to the first and second switching transistors S4 and S5, a heat dissipation effect is greater than that of the driver 1100 of the plasma display using one switching transistor S1 according to the first exemplary embodiment of the present invention, and additional design for heat dissipation is not required.

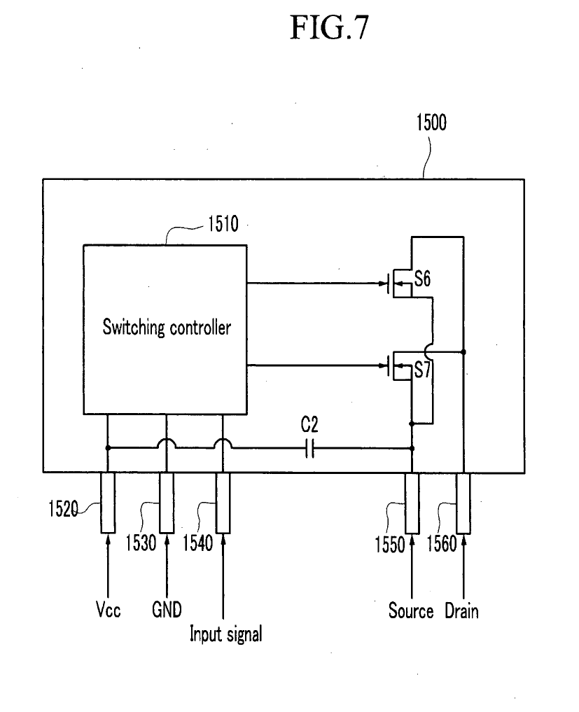

FIG. 7 is a diagram of a plasma display driver according to a fifth exemplary embodiment of the present invention.

The driver 1500 of the plasma display of FIG. 7 according to the fifth exemplary embodiment of the present invention is similar to the driver 1400 of the plasma display of FIG. 6 according to the fourth exemplary embodiment of the present invention except that the bootstrap voltage input terminal is not provided.

As shown in FIG. 7, the driver 1500 of the plasma display according to the fifth exemplary embodiment of the present invention includes a bootstrap capacitor C2 having a terminal coupled to a first input and output terminal 1520 and another terminal coupled to a common source terminal of a first switching transistor S6 and a second switching transistor S7. Since the bootstrap capacitor C2 is charged by a power source voltage Vcc input through the first input and output terminal 1520, a voltage level of an output signal output through the common source terminal of the first switching transistor S6 and the second switching transistor S7 is increased.

Since the number of input and output terminals is reduced while the driver 1500 of the plasma display according to the fifth exemplary embodiment of the present invention has the same performance as the driver 1400, patterning design of a printed substrate may be simplified.

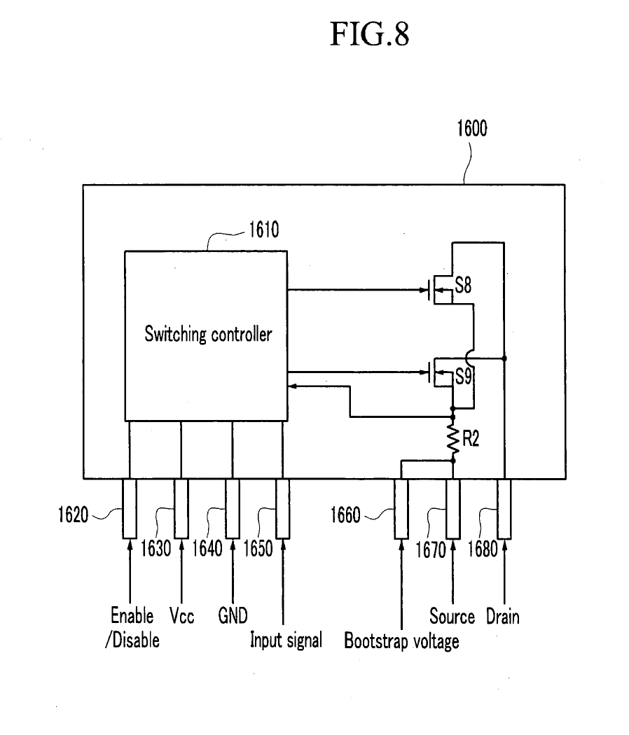

FIG. 8 is a diagram of a plasma display driver according to a sixth exemplary embodiment of the present invention.

The driver 1600 of the plasma display of FIG. 8 according to the sixth exemplary embodiment of the present invention is a one-chip driver that is similar to the drivers 1400 and 1500 of the plasma display shown in FIGS. 6 and 7 according to the fourth and fifth exemplary embodiments of the present invention, and therefore, descriptions of previously described parts have been omitted.

The switching controller 1610 receives an enable or disable signal through a first input and output terminal 1620 for receiving an external control signal for controlling an operation of the driver 1600 of the plasma display according to the sixth exemplary embodiment of the present invention. The switching controller 1610 outputs a switching control signal according to an input signal input through a fourth input and output terminal 1650 and operates first and second switching transistors S8 and S9 when receiving the enable signal through the first input and output terminal 1620, and turns off the first and second switching transistors S8 and S9 regardless of the input signal when receiving the disable signal.

In addition, a resistor R2 is connected to a common source terminal of the first and second switching transistors S8 and S9, and a voltage corresponding to a current flowing through a source terminal 1670 is input to the switching controller 1610 through the resistor R2. The switching controller 1610 compares the input voltage to a predetermined reference voltage. When the input voltage is higher than reference voltage, the switching controller 1610 turns off first and second switching transistors S8 and S9 for a predetermined time to prevent over-currents through the source terminal 1670 and to prevent neighboring circuits from being damaged.

Differing from the driver 1600 of the plasma display of FIG. 8 according to the sixth exemplary embodiment of the present invention, a fifth input and output terminal 1660 for receiving the bootstrap voltage is eliminated, and a bootstrap capacitor having a terminal coupled to a second input and output terminal 1630 and another terminal coupled to the common source terminal of the first and second switching transistors S8 and S9 in a like manner of the driver 1500 of the plasma display of FIG. 7 according to the fifth exemplary embodiment of the present invention.

In the driver 1600 of the plasma display according to the sixth exemplary embodiment of the present invention, since functions for controlling the driver 1600 by using the external control signal and preventing the over-current are additionally provided to the drivers according to the fourth and fifth exemplary embodiments of the present invention, the PDP 100 of FIG. 2 may be driven according to the intention of a circuit designer.

Since a driving board to which the driver is mounted is easily designed, and the number of constituent elements is reduced in the drivers 1100, 1200, 1300, 1400, 1500, and 1600 according to the exemplary embodiments of the present invention, costs are reduced, and circuits are simplified. In addition, when a problem of ElectroMagnetic Interference (EMI) is generated, it is necessary to modify a circuit design in a conventional IPM or HVIC. However, there is no element for causing the EMI in the driver of the plasma display according to the exemplary embodiment of the present invention, and therefore, it is necessary to correct circuits neighboring the driver according to the exemplary embodiment of the present invention without modifying the driver according to the exemplary embodiment of the present invention.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

According to the exemplary embodiments of the present invention, various problems, such as a difficulty in patterning design of the driving board on which the driver of the plasma display is mounted, the number of layers of the printed substrate, noise, ground pattern shortage, and output voltage distortion, may be solved.

In addition, the number of constituent elements may be reduced, a manufacturing process may be simplified, a manufacturing cost may be reduced, and it is not necessary to perform additional design for heat dissipation.

What is claimed is:

1. A plasma display driver to drive first and second electrodes of a plasma display, and to drive a third electrode of the plasma display arranged in a direction crossing the first and second electrodes in response to an input signal input from a controller, the driver that is formed by one chip comprising:
a first switching transistor;
a switching controller to generate a switching control signal, according to the input signal, to control turning a first switching transistor on and off;
first to third input and output terminals to output a power source voltage, a ground voltage, and the input signal to the switching controller; and
fourth and fifth input and output terminals respectively coupled to a drain and a source of the first switching transistor.

2. The driver of claim 1, further comprising a second switching transistor including a source and drain that are commonly respectively coupled to the source and drain of the first switching transistor, the second switching transistor operating in response to the switching control signal.

3. The driver of claim 1, further comprising a sixth input and output terminal to output a driving control signal to the switching controller control to control an operation thereof.

4. The driver of claim 3, wherein the switching controller generates the switching control signal corresponding to a level of the input signal according to the driving control signal, or turns off the switching transistor regardless of the input signal.

5. The driver of claim 1, further comprising a first resistor including a terminal coupled to the source terminal of the first switching transistor and another terminal coupled to the fifth input and output terminal, and a voltage detection path to transmit a first voltage, corresponding to currents flowing from the source terminal to the fifth input and output terminal, to the switching controller through the first resistor.

6. The driver of claim 5, wherein the switching controller varies the switching control signal according to a level of the first voltage.

7. The driver of claim 1, further comprising a first capacitor including a terminal coupled to the first input and output terminal and another terminal coupled to the source terminal of the first switching transistor.

8. The driver of claim 1, further comprising a seventh input and output terminal coupled to the source terminal of the switching transistor.

9. A plasma display comprising:
a Plasma Display Panel (PDP) having first and second electrodes, and having a third electrode arranged in a direction crossing the first and second electrodes;
first to third driving circuit units to respectively driving the first to third electrodes; and
a controller to supply a control signal to the first to third driving circuit units;
wherein the first to third driving circuit units respectively formed by one chip each include:
a first switching transistor;
a switching controller to generating a switching control signal to turn the first switching transistor on and off in response to the control signal;
first to third input and output terminals to respectively output a power source voltage, a ground voltage, and the input signal to the switching controller; and
fourth and fifth input and output terminals respectively coupled to a drain and a source of the first switching transistor.

10. The plasma display of claim 9, further comprising a second switching transistor including a source and drain that are commonly respectively coupled to the source and drain of the first switching transistor, the second switching transistor operating in response to the switching control signal.

11. The plasma display of claim 9, further comprising a sixth input and output terminal to output a driving control signal to the switching controller control to control an operation thereof.

12. The plasma display of claim 11, wherein the switching controller generates the switching control signal corresponding to a level of the input signal according to the driving control signal, or turns off the switching transistor regardless of the input signal.

13. The plasma display of claim 9, further comprising a first resistor including a terminal coupled to the source terminal of the first switching transistor and another terminal coupled to the fifth input and output terminal, and a voltage detection path to transmit a first voltage, corresponding to currents flowing from the source terminal to the fifth input and output terminal, to the switching controller through the first resistor.

14. The plasma display of claim 13, wherein the switching controller varies the switching control signal according to a level of the first voltage.

15. The plasma display of claim 9, further comprising a first capacitor including a terminal coupled to the first input and output terminal and another terminal coupled to the source terminal of the first switching transistor.

16. The plasma display of claim 9, further comprising a seventh input and output terminal coupled to the source terminal of the switching transistor.
